(19) United States
(12) Patent Application Publication
(10) Pub. No.: US 2018/0140974 A1
(43) Pub. Date: May 24, 2018

(54) EXCHANGE UNIT AND FLOW CIRCUIT SYSTEM USING SAME

(71) Applicant: ROKI TECHNO CO., LTD., Tokyo (JP)

(72) Inventors: Tetsuya UCHIDA, Tokyo (JP); Takashi YAMASAKI, Tokyo (JP)

(21) Appl. No.: 15/574,815

(22) PCT Filed: May 18, 2015
(86) PCT No.: PCT/JP2015/002494

§ 371 Date: Nov. 16, 2017

(51) Int. Cl. B01D 27/08; B01D 35/30

(52) U.S. Cl. CPC B01D 27/08; B01D 2201/30; B01D 2201/32; B01D 35/30

(57) ABSTRACT

The exchange unit includes a first flow path end portion having a first width; a main body portion having a second width larger than the first width; a second flow path end portion positioned on a side opposite to the first flow path end portion; and a slide extension portion including a portion larger than the first width and is configured to cover the first flow path end portion on an outer side of the first flow path end portion, and a portion larger than the second width and is configured to cover the main body portion on an outer side of the main body portion. The exchange unit is removably mounted to an existing pipeline with a distance between an upstream-side end portion of a pipeline and a downstream-side end portion of the pipeline being invariable only by a translational operation without using a rotating operation.

### TECHNICAL FIELD

The invention of the present application relates to an exchange unit, which includes, for example, a filter or other members built therein, and is removably mounted so as to be replaceable as a part of an existing pipeline to enable formation of the pipeline, and to a flow circuit system using the same.

### BACKGROUND ART

For a pipeline provided for the purpose of filtration of a fluid, an exchange unit, which includes a filter or other members built therein, and is removable so as to be replaceable, is provided as a part of the pipeline. For example, after a predetermined amount of filtration is completed, an old exchange unit is removed to be replaced by a new exchange unit. The pipeline described above lacks a part thereof between an upstream-side end portion of the pipeline and a downstream-side end portion of the pipeline. The exchange unit has a structure which allows removable mounting thereof between the upstream-side end portion of the pipeline and the downstream-side end portion of the pipeline. The exchange unit has a flow path formed inside, and has a flow path inlet and a flow path outlet at both ends of the flow path. The filter or other members is arranged in the flow path. In general, the upstream-side end portion of the pipeline and the downstream-side end portion of the pipeline are constructed as a part of a manifold. When the exchange unit is mounted to the manifold, the flow path inlet of the exchange unit is joined to the upstream-side end portion of the pipeline, whereas the flow path outlet is jointed to the downstream-side end portion of the pipeline. In this manner, the flow path of the exchange unit is coupled to the partially lacking pipeline to complete a pipeline of a flow circuit system.

### CITATION LIST

### Patent Literature

PTL 1: Japanese Patent No. 4723531

PTL 2: Japanese Patent Application Laid-Open No. H3-123689

### SUMMARY OF INVENTION

### Technical Problem

In Patent Literature 1, there is disclosed an example of the exchange unit which is removably mounted so as to be replaceable as a part of an existing pipeline to enable the formation of the pipeline. In Patent Literature 1, a distance between the upstream-side end portion of the pipeline of the manifold and the downstream-side end portion of the pipeline of the manifold is invariable. The exchange unit is mounted between those end portions by a pivoting operation using any one of the flow path inlet and the flow path outlet of the exchange unit as a pivot axis. In the mounting of the exchange unit by the pivoting operation, however, the end on the side opposite to the pivot axis has a large range of motion. Therefore, a friction occurs on a sealing member of exchange unit due to bias. Thus, wear of the sealing member becomes large.

Meanwhile, in Patent Literature 2, there is disclosed a water purifier cartridge to be used in a sink. In Patent literature 2, there are disclosed a manifold including a slidable sleeve pipe and the water purifier cartridge. On the manifold side, the distance between the upstream-side end portion of the pipeline and the downstream-side end portion of the pipeline remains unvaried. As the water purifier cartridge disclosed in Patent Literature 2, there is disclosed the water purifier cartridge in which one end of a flow path of the water purifier cartridge is screwed into one end of a pipeline of the manifold and the sleeve pipe of the manifold is extended to be coupled to another end of the pipeline of the manifold. However, the coupling using screwing is complicated for an engineer. At the same time, for a fluid having a high pressure, a form in which the slidable sleeve pipe is simply extended to be coupled to the another end of the pipeline of the manifold cannot be adopted. Further, in an industrial filtering device for which a filtered target is liable to be solidified, when a movable section is provided on the manifold, an adhesive substance contained in the fluid firmly adheres to a movable portion of the movable section, which is disadvantageous. Further, for a narrow sleeve pipe having only a single diameter as disclosed in Patent Literature 2, a sliding operation is difficult without a given length. Further, it is difficult to provide a structure which ensures stiffness. In the case of the form disclosed in Patent Literature 2, in particular, it is difficult to hold the sliding pipe in the form of inserting the pipe into a recess.

### Solution to Problem

In order to solve the above-mentioned problems, there is provided an exchange unit removably mounted between a first pipeline end portion and a second pipeline end portion of a manifold of a flow circuit, the manifold including the first pipeline end portion having a recessed portion and the second pipeline end portion, the exchange unit including: a first flow path end portion having a first width; a main body portion having a second width larger than the first width; a second flow path end portion positioned on a side opposite to the first flow path end portion; and a slide extension portion including a portion, which is larger than the first width and is configured to cover the first flow path end portion on an outer side of the first flow path end portion, and a portion, which is larger than the second width and is configured to cover the main body portion on an outer side of the main body portion, in which the slide extension portion is capable of being extended from the main body portion along the main body portion and the first flow path end portion, and is capable of being inserted into the recessed portion of the first pipeline end portion when the slide extension portion is extended.

Further, in order to solve the above-mentioned problems, there is provided a flow circuit system including a manifold being a part of a flow circuit and an exchange unit mountable to and removable from the manifold, the manifold including a first pipeline end portion having a recessed portion and a second pipeline end portion, the exchange unit including: a first flow path end portion having a first width; a main body portion having a second width larger than the first width; a second flow path end portion positioned on a side opposite to the first flow path end portion; and a slide extension portion including a portion, which is larger than the first width and is configured to cover the first flow path end portion on an outer side of the first flow path end portion, and a portion, which is larger than the second width and is configured to cover the main body portion on an outer side of the main body portion, in which the slide extension portion is capable of being extended from the main body portion along the main body portion and the first flow path end portion, and is capable of being inserted into the recessed portion of the first pipeline end portion when the slide extension portion is extended.

Further, in order to solve the above-mentioned problems, there is provided an exchange unit to be removably mounted, in a predetermined mounting direction, between a first pipeline end portion and a second pipeline end portion of a manifold of a flow circuit, the manifold including the first pipeline end portion and the second pipeline end portion opposed to the first pipeline end portion, the exchange unit including: a main body portion; a first flow path end portion, which extends from the main body portion; a second flow path end portion, which has a flange and extends from the main body portion in a direction opposite to a direction in which the first flow path end portion extends; and a slide extension portion, which has a flange on a side opposite to the main body portion and is movable with respect to the main body portion along the first flow path end portion, in which, in the predetermined mounting direction for the exchange unit, the first pipeline end portion of the manifold has an opening capable of receiving the flange of the slide extension portion, whereas the second pipeline end portion of the manifold has an opening capable of receiving the flange of the second flow path end portion; and in which the flange of the slide extension portion is inserted into the opening of the first pipeline end portion of the manifold and the flange of the second flow path end portion is inserted into the opening of the second pipeline end portion of the manifold so that the slide extension portion is moved relative to the main body portion to change a distance between the flange of the slide extension portion and the flange of the second flow path end portion, to thereby mount the exchange unit between the first pipeline end portion and the second pipeline end portion.

In order to solve the above-mentioned problems, there is provided a flow circuit system including a manifold being a part of a flow circuit and an exchange unit mountable to and removable from the manifold, the manifold including a first pipeline end portion and a second pipeline end portion, the exchange unit to be removably mounted between the first pipeline end portion and the second pipeline end portion in a predetermined mounting direction, the exchange unit including: a main body portion; a first flow path end portion, which extends from the main body portion; a second flow path end portion, which has a flange and extends from the main body portion in a direction opposite to a direction in which the first flow path end portion extends; and a slide extension portion, which has a flange on a side opposite to the main body portion and is movable along the first flow path end portion with respect to the main body portion, in which, in the predetermined mounting direction for the exchange unit, the first pipeline end portion of the manifold has an opening capable of receiving the flange of the slide extension portion, whereas the second pipeline end portion of the manifold has an opening capable of receiving the flange of the second flow path end portion, and in which the flange of the slide extension portion is inserted into the opening of the first pipeline end portion of the manifold and the flange of the second flow path end portion is inserted into the opening of the second pipeline end portion of the manifold so that the slide extension portion is moved relative to the main body portion to change a distance between the flange of the slide extension portion and the flange of the second flow path end portion, to thereby mount the exchange unit between the first pipeline end portion and the second pipeline end portion.

In order to solve the above-mentioned problems, there is provided an exchange unit to be removably mounted, in a predetermined mounting direction, between a first pipeline end portion and a second pipeline end portion of a manifold of a flow circuit, the manifold including the first pipeline end portion and the second pipeline end portion opposed to the first pipeline end portion, the exchange unit including: a main body portion, which has an opening at one end; a first flow path end portion, which has a flange and extends from the main body portion; and a second flow path end portion, which has a closing surface configured to cover the opening of the main body portion at one end and a flange at another end, extends on a side opposite to the main body portion, and is mounted movably with respect to the main body portion, in which, in the predetermined mounting direction for the exchange unit, the first pipeline end portion of the manifold has an opening capable of receiving the flange of the first flow path end portion, whereas the second pipeline end portion of the manifold has an opening capable of receiving the flange of the second flow path end portion, and in which the flange of the first flow path end portion is inserted into the opening of the first pipeline end portion of the manifold and the flange of the second flow path end portion is inserted into the opening of the second pipeline end portion of the manifold so that the second flow path end portion is moved relative to the main body portion to change a distance between the flange of the first flow path end portion and the flange of the second flow path end portion, to thereby mount the exchange unit between the first pipeline end portion and the second pipeline end portion.

In order to solve the above-mentioned problems, there is provided a flow circuit system including a manifold being a part of a flow circuit and an exchange unit mountable to and removable from the manifold, the manifold including a first pipeline end portion and a second pipeline end portion, the exchange unit to be removably mounted between the first pipeline end portion and the second pipeline end portion in a predetermined mounting direction, the exchange unit including: a main body portion, which has an opening at one end; a first flow path end portion, which has a flange and extends from the main body portion; and a second flow path end portion, which has a closing surface configured to cover the opening of the main body portion at one end and a flange at another end, extends on a side opposite to the main body portion, and is mounted movably with respect to the main body portion, in which, in the predetermined mounting direction for the exchange unit, the first pipeline end portion of the manifold has an opening capable of receiving the flange of the first flow path end portion, whereas the second pipeline end portion of the manifold has an opening capable of receiving the flange of the second flow path end portion, and in which the flange of the first flow path end portion is inserted into the opening of the first pipeline end portion of the manifold and the flange of the second flow path end portion is inserted into the opening of the second pipeline end portion of the manifold so that the second flow path end portion is moved relative to the main body portion to change a distance between the flange of the first flow path end portion and the flange of the second flow path end portion, to thereby mount the exchange unit between the first pipeline end portion and the second pipeline end portion.

### Advantageous Effects of Invention

According to the present invention, the exchange unit can be removably mounted to an existing pipeline with a distance between an upstream-side end portion of a pipeline and a downstream-side end portion of the pipeline being invariable only by a translational operation without using a rotating operation about any one of the upstream-side end portion of the pipeline and the downstream-side end portion of the pipeline as a center of rotation.

### BRIEF DESCRIPTION OF DRAWINGS

FIG. 1 is a diagram for illustrating an exchange unit and a part of a flow circuit to which the present invention is applied.

FIG. 2 is a sectional view taken along the line 2-2 in FIG. 1, for illustrating a positional relationship between the exchange unit and a manifold immediately before the exchange unit of the present invention is mounted to the manifold.

FIG. 3 is a view for illustrating an example of a structure for allowing a slide extension portion to be extended along a main body portion.

FIG. 4 is an enlarged view of a vicinity of a flange surface of the exchange unit when the flange surface is mounted to the manifold.

FIG. 5 is a view for illustrating a state in which one end of the exchange unit is mounted to the manifold.

FIG. 6 is a view for illustrating a state in which the exchange unit is completely mounted to the manifold.

FIG. 7 is a view of an exchange unit in a first mode of a second embodiment of the present invention, for illustrating a state before mounting.

FIG. 8 is a view of the exchange unit in the first mode of the second embodiment, for illustrating a state after the mounting.

FIG. 9 is a view of the exchange unit in a second mode of the second embodiment, for illustrating a state before mounting.

FIG. 10 is a view of the exchange unit in the second mode of the second embodiment, for illustrating a state after the mounting.

### DESCRIPTION OF EMBODIMENTS

### First Embodiment

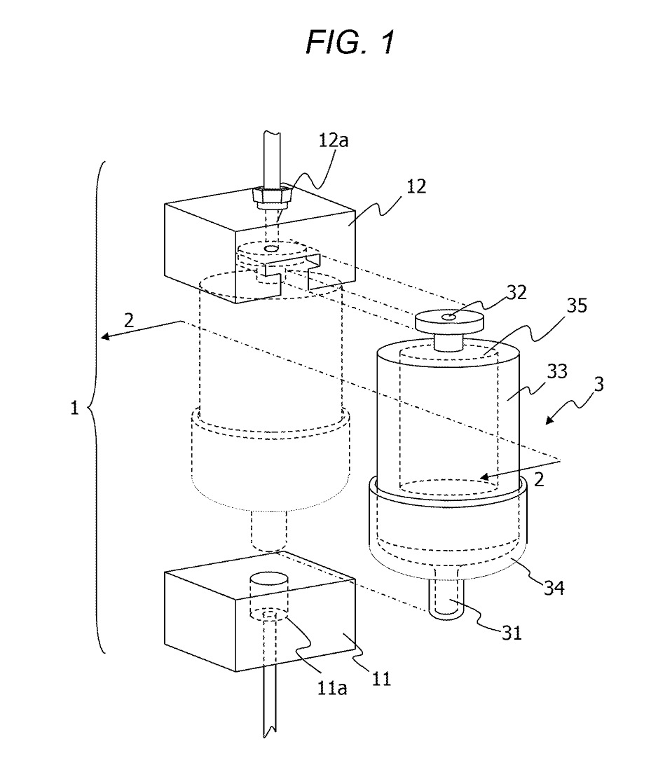

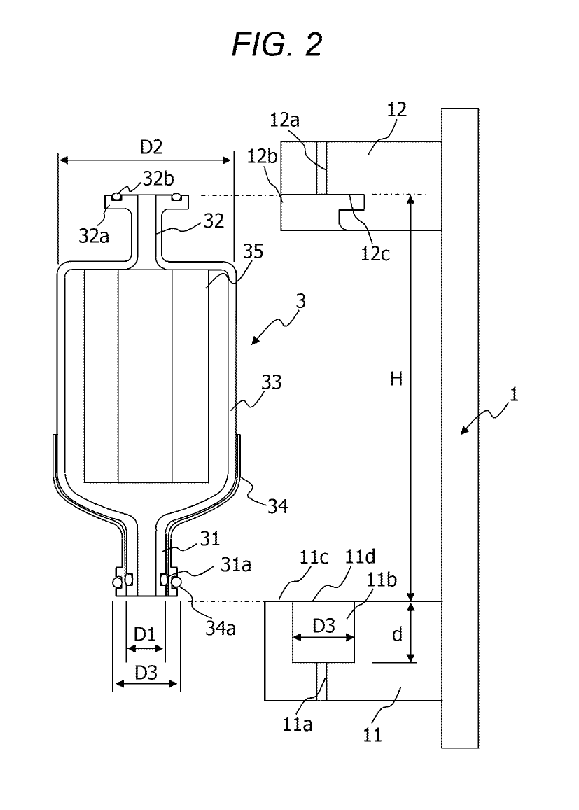

With reference to FIG. 1 to FIG. 4, embodiments of the invention of the present application are described. FIG. 1 is a diagram for illustrating a part of a flow circuit. FIG. 2 is a sectional view taken along the line 2-2 in FIG. 1. A manifold 1 is provided on the flow circuit. The manifold 1 includes a first pipeline end portion 11 and a second pipeline end portion 12. The flow circuit in which the manifold 1 is mounted has a flow-path lacking portion between the first pipeline end portion 11 and the second pipeline end portion 12. The first pipeline end portion 11 and the second pipeline end portion 12 are arranged so as to be opposed to each other, and each can be constructed as, for example, a block-like member. For example, a pipeline 11a connected to a fluid source (not shown) is connected to the first pipeline end portion 11 to enable formation of an upstream side of the flow circuit, whereas a pipeline 12a connected to a destination of exhaust of the fluid (not shown) is connected to the second pipeline end portion 12 to enable formation of a downstream side of the flow circuit. However, a relationship between the upstream side and the downstream side of the manifold 1 is merely an example, and can be set oppositely. Hereinafter, the first pipeline end portion 11 side is described as the upstream side, and the second pipeline end portion 12 is described as the downstream side as an example in this specification.

The first pipeline end portion 11 has an opposed surface 11c, and the second pipeline end portion 12 has an opposed surface 12c. The opposed surface 11c and the opposed surface 12c are opposed to each other. A distance H between the surface 11c and the surface 12c which are opposed to each other is invariable. An exchange unit 3 is removably mounted in the distance H.

The second pipeline end portion 12 has an opening 12b in a lateral direction with respect to a direction from the opposed surface 12c to the opposed surface 11c. The direction from the opposed surface 12c to the opposed surface 11c is representatively a normal direction to the opposed surface 12c. As long as the direction is the lateral direction with respect to the direction from the opposed surface 12c to the opposed surface 11c, however, the direction is not necessarily required to be the normal direction in a strict sense. The first pipeline end portion 11 includes a recessed portion 11b having a depth d in an extension direction in the direction from the opposed surface 12c of the second pipeline end portion 12 to the opposed surface 11c of the first pipeline end portion 11.

The pipeline 11a connected to the fluid source (not shown) is connected to the recessed portion 11b, whereas the pipeline 12a connected to the destination of exhaust of the fluid is connected to the opposed surface 12c. In general, it is preferred that the pipeline 11a of the first pipeline end portion 11 and the pipeline 12a of the second pipeline end portion 12 be arranged so as to be positioned in the same straight line to reduce a flow path resistance. However, the positions thereof may be shifted, or one of the pipelines may be inclined with respect to another thereof. The recessed portion 11b is formed so that an axial direction of the pipeline 11a of the first pipeline end portion 11 coincides with a depth direction of the recessed portion 11b. The recessed portion 11b is formed on the first pipeline end portion 11. Therefore, when a pipe opening of the exchange unit 3 is inserted thereto, the pipe opening of the exchange unit 3 is inserted in the direction from the opposed surface 12c to the opposed surface 11c. When the pipeline 11a of the first pipeline end portion 11 and the pipeline 12a of the second pipeline end portion 12 are arranged in the same straight line, the pipe opening of the exchange unit 3 is inserted in the axial direction of the pipeline 11a of the first pipeline end portion 11. Meanwhile, the opening 12b of the second pipeline end portion 12 is formed in a lateral direction with respect to (representatively, a perpendicular direction to) a direction of extension of the pipeline 12a of the second pipeline end portion 12.

In the first embodiment, there is described an example where the recessed portion 11b having an opening 11d which is formed along the direction of extension of the pipeline is formed on the first pipeline end portion 11 positioned on a lower side of the manifold 1 and the opening 12b which is formed along the perpendicular direction to the direction of extension of the pipeline is formed on the second pipeline end portion 12 positioned on the upper side of the manifold 1. However, the recessed portion 11b may be formed on the second pipeline end portion 12 on the upper side of the manifold 1, and the opening 12b formed in the perpendicular direction to the direction of extension of the pipeline may be formed on the first pipeline end portion 11 on the lower side of the manifold 1.

Specifically, the manifold 1 constructing a part of the flow circuit system according to the present invention is the flow-path lacking portion being a part of the flow circuit. A flow path inside the exchange unit 3 is joined between the first pipeline end portion 11 being one end of the lacking portion and the second pipeline end portion 12 being another end thereof, thereby completing the flow circuit system. Then, the opening 12b is formed at the one end of the manifold 1 being the flow-path lacking portion in the lateral direction with respect to the direction from the one end to the another end, whereas the recess 11b drilled in a direction from the one end to the another end is formed at the another end of the manifold 1.

The exchange unit 3 includes a first flow path end portion 31, a second flow path end portion 32, a main body portion 33, and a slide extension portion 34. The main body portion 33 has a hollow portion inside, and hence, for example, a filter 35 or other members may be arranged in the hollow portion. The filter 35 or other members is a filter member with an ion-exchange resin, an adsorbent such as zeolite or a diatom earth, a member obtained by combining the adsorbent and the filter member, or the like. Inside the exchange unit 3, a flow path from the first flow path end portion 31 through the filter 35 or other members to the second flow path end portion 32 is formed. The first flow path end portion 31 has, for example, a first width D1. The first flow path end portion 31 can representatively have a cylindrical shape having the first width D1 as a diameter, as illustrated in FIG. 2. The main body portion 33 has, for example, a second width D2. The main body portion 33 can representatively have a cylindrical shape having the second width D2 as a diameter, as illustrated in FIG. 2. A shape from the first flow path end portion 31 to the main body portion can be such that a width thereof smoothly changes from the first width D1 to the second width D2.

The slide extension portion 34 is mounted on the first flow path end portion 31 side of the exchange unit 3. The slide extension portion 34 has such a shape as to cover at least a part of the first flow path end portion 31 and the main body portion 33. A portion of the slide extension portion 34, which is positioned on an outer side of the first flow path end portion 31, has an inner diameter being approximately equal to the first width D1, whereas a portion of the slide extension portion 34, which is positioned on an outer side of the main body portion 33, has an inner diameter being approximately equal to the second width D2. Specifically, the slide extension portion 34 includes the portion, which is larger than the first width D1 and is configured to cover the main body portion 33 on the outer side of the main body portion 33, and the portion, which is larger than the second width D2 and is configured to cover the first flow path end portion 31 on the outer side of the first flow path end portion 31. In the portion of the slide extension portion 34, which is positioned on the outer side of the first flow path end portion 31, a sealing member 31a such as an O-ring configured to seal a gap between an outer surface of the first flow path end portion 31 and an inner surface of the slide extension portion 34 is provided.

The portion of the slide extension portion 34, which is positioned on the outer side of the first flow path end portion 31, is slidable along the first flow path end portion 31, whereas the portion thereof, which is positioned on the outer side of the main body portion 33, is slidable along the main body portion 33. For example, a guide groove is formed on an inner side of the portion which is positioned on the outer side of the main body portion 33. A part of the main body portion 33 is engaged with the guide groove so that the slide extension portion 34 slides therein. The guide groove may be formed along a direction in which the first flow path end portion 31 extends or may be formed in a spiral shape about the direction in which the first flow path end portion 31 extends. In the former case, the slide extension portion 34 moves to be extended along the direction in which the first flow path end portion 31 extends. In the latter case, the slide extension portion 34 is extended while rotating about the direction in which the first flow path end portion 31 extends. Those arrangements are selectable in accordance with a purpose of use. The slide extension portion 34 is extended to be inserted into the recessed portion 11b of the first pipeline end portion 11 of the manifold 1. A sealing member 34a such as the O-ring is provided on an outer surface side of a distal end of the slide extension portion 34.

The recessed portion 11b of the manifold 1 has, for example, a third width D3, and can be representatively formed to have a cylindrical shape having the third width D3 as a diameter, as illustrated in FIG. 2. The slide extension portion 34 has an outer diameter being approximately equal to the third width D3. The width (diameter) is set to such a width (diameter) as to allow the slide extension portion 34 to be inserted and slidable in the recessed portion 11b in a state in which the sealing member 34a is pressed against an inner wall of the recessed portion 11b.

The slide extension portion 34 is extended from a received state of being received on the outer side of the main body portion 33 to an extended state in which the distal end of the slide extension portion 34 is extended beyond a distal end of the first flow path end portion 31. The exchange unit 3 has a smaller total length between the first flow path end portion 31 and the second flow path end portion 32 than the distance H between the pipeline 11a of the first pipeline end portion 11 of the manifold 1 and the pipeline 12a of the second pipeline end portion 12 under the received state of the slide extension portion 34, and has a larger total length between the first flow path end portion 31 and the second flow path end portion 32 than the distance H under the extended state of the slide extension portion 34. Further, the exchange unit 3 is arranged within a range having the first width D1 so that the sealing member 31a arranged on the first flow path end portion 31 is positioned on the outer side of the first flow path end portion 31 provided on the slide extension portion 34 even under the extended state in which extension of the slide extension portion 34 becomes the longest. Therefore, even under the extended state in which the extension of the slide extension portion 34 is the longest, the sealing member 31a of the first flow path end portion 31 and the slide extension portion 34 are held in close contact with each other to prevent the fluid from leaking. It is preferred to set the inner diameter of the slide extension portion 34 and an outer diameter of the first flow path end portion 31 to be constant so that the gap between the outer surface of the first flow path end portion 31 and the inner surface of the slide extension portion 34 is constantly sealed by the sealing member 31a at any position between the received state and the extended state. Although it is general to provide the sealing member 31a on the outer surface of the first flow path end portion 31 so as to seal the gap between the outer surface of the first flow path end portion 31 and the inner surface of the slide extension portion 34, the sealing member 31a may be provided on the inner surface side of the slide extension portion 34.

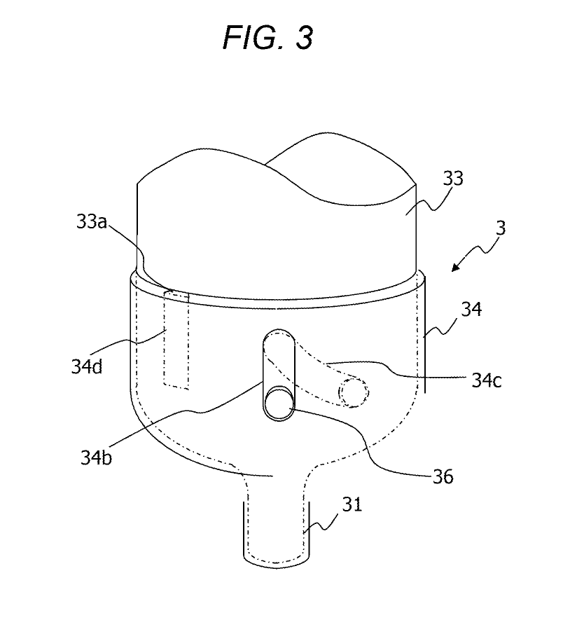

FIG. 3 is a view for illustrating an example of a structure for extending the slide extension portion 34 along the main body portion 33. An engaging portion is provided on the main body portion 33, whereas a receiving portion configured to receive the engaging portion is provided on the slide extension portion 34 so that the slide extension portion 34 is caused to slide along the main body portion 33 while the engaging portion is engaged with the receiving portion. For example, as one example, a projection 36 being the engagement portion is formed on the main body portion 33, as indicated by the solid line in FIG. 3. An elongated hole 34b is drilled as the receiving portion into the slide extension portion 34, in which the projection 36 is movable. The projection 36 moves along the elongated hole 34b so that the distal end of the slide extension portion 34 can be extended to the extended state in which the distal end of the slide extension portion 34 is extended beyond the distal end of the first flow path end portion 31. A length of the elongated hole 34b is set to correspond to a travel distance of the slide extension portion 34. As another example, the receiving portion in which the projection 36 being the engaging portion is movable is drilled obliquely. As indicated by the alternate long and short dash line, an elongated hole 34c having a spiral shape is formed as the receiving portion in the slide extension portion 34 so that the projection 36 is movable in the elongated hole 34c. In this manner, the distal end of the slide extension portion 34 can be extended to the extended state in which the distal end of the slide extension portion 34 is extended beyond the distal end of the first flow path end portion 31. Further, as another example, an elongated projection 33a is formed as the engaging portion on the main body portion 33, whereas an engagement groove 34d to be brought into engagement with the elongated projection 33a is formed as the receiving portion in an inner surface of the slide extension portion 34. In this case, the slide extension portion 34 can be extended while the elongated projection 33a is engaged with the engagement groove 34. A length of the elongated projection 33a and the engagement groove 34 can be set to correspond to a distance over which the slide extension portion 34 is desired to be extended. In this manner, as the structure for extending the slide extension portion 34 along the main body portion 33, the engaging portion and the receiving portion can be achieved in various modes.

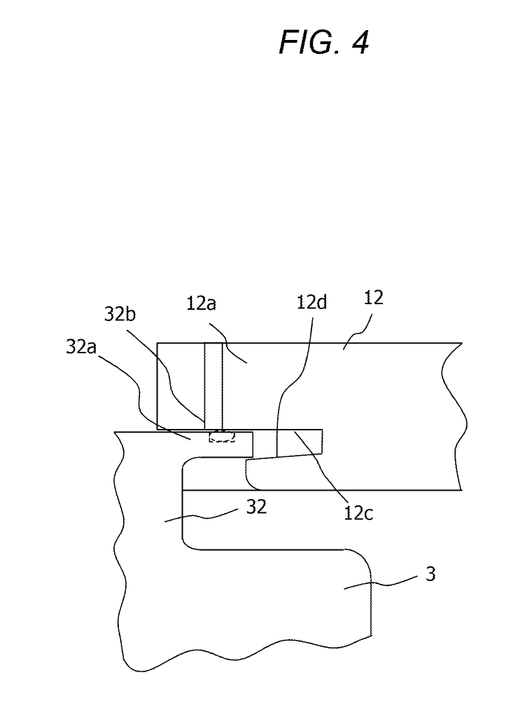

On the second flow path end portion 32 side of the exchange unit 3, a flange 32a is mounted. A sealing member 32b such as an O-ring is provided on a flange surface of the flange 32a. FIG. 4 is a sectional view for illustrating a portion of the flange 32a and the second pipeline end portion 12 of the manifold 1 in an enlarged manner. The flange 32a can be inserted into the second pipeline end portion 12 of the manifold 1 through the opening 12b of the second pipeline end portion 12 in the perpendicular direction to the pipeline 12a of the second pipeline end portion 12. After the flange 32a is inserted into the opening 12b, the flange surface is spontaneously pressed against a flange abutment surface 12c of the pipeline 12a of the second pipeline end portion 12. For example, an inclined surface 12d is formed on a side opposite to the flange abutment surface 12c of the second pipeline end portion 12. Inclination of the inclined surface 12d is such that a distance between the flange abutment surface 12c and the inclined surface 12d is reduced as the flange 32a is inserted inside through the opening 12b. In this manner, as the flange 32a is inserted into the opening 12b, the flange surface of the flange 32a is firmly pressed against the flange abutment surface 12c of the second pipeline end portion 12 under a wedge effect.

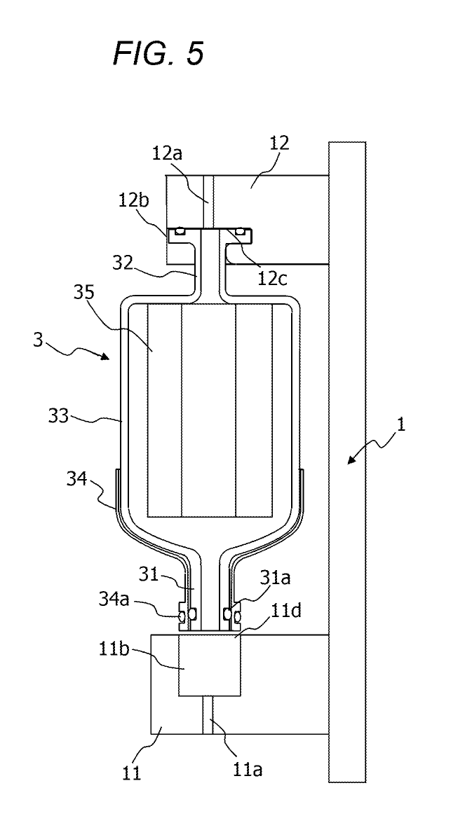

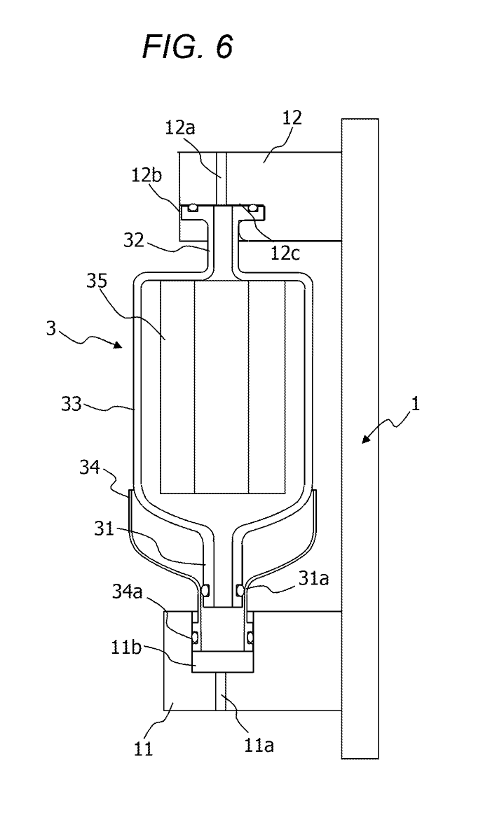

Subsequently, with reference to FIG. 2, FIG. 5, and FIG. 6, there is described how the exchange unit 3 is mounted to the manifold 1. FIG. 2 is a view for illustrating a positional relationship between the exchange unit 3 and the manifold 1 immediately before the exchange unit 3 is mounted to the manifold 1. FIG. 5 is a view for illustrating a state in which the second flow path end portion 32 being one end of the exchange unit 3 is mounted to the manifold 1. FIG. 6 is a view for illustrating a state in which the exchange unit 3 is completely mounted to the manifold 1. An engineer places the exchange unit 3 in the vicinity of the manifold 1 so that the first flow path end portion 31 of the exchange unit 3 is oriented toward the first pipeline end portion 11 of the manifold 1 and the second flow path end portion 32 of the exchange unit 3 is oriented toward the second pipeline end portion 12 of the manifold 1 (FIG. 2). Then, the exchange unit 3 is placed by inserting the flange 32a of the exchange unit 3 into the opening 12b of the second pipeline end portion 12 of the manifold 1 by a translational operation so that the exchange unit 3 is positioned between the first pipeline end portion 11 and the second pipeline end portion 12 of the manifold 1 (FIG. 5). As the flange 32a of the exchange unit 3 is inserted into the opening 12b, the flange 32a is pressed harder against the opposed surface 12c. After the flange 32a of the exchange unit 3 is completely inserted into the opening 12b, the slide extension portion 34 of the exchange unit 3 is extended so that the slide extension portion 34 is inserted into the recessed portion 11b (FIG. 6). In this manner, the mounting of the exchange unit 3 to the manifold 1 is completed. For removing the exchange unit 3 from the manifold 1, a reverse process to the above-mentioned process is carried out.

When the slide extension portion 34 is inserted into the recessed portion 11b to be fixed thereto, the inner wall of the recessed portion 11b and the sealing member 34a provided on an outer portion of the slide extension portion 34 are held in close contact with each other, and an inner wall of the slide extension portion 34 and the sealing member 31a provided on the main body portion 33 of the exchange unit 3 are held in close contact with each other. As a result, the fluid flowing from the pipeline 11a on the upstream side is introduced inside the exchange unit 3 without leaking externally. Further, the flange 32a is held in close contact with the opposed surface 12c. As a result, the fluid flowing out of the inside of the exchange unit 3 is introduced into the pipeline 12a on the downstream side without leaking externally. In this manner, the exchange unit 3 is easily mounted to the manifold 1 by the translational operation without applying a biased force to the sealing members.

In the case of the first embodiment, the slide extension portion 34 of the exchange unit 3 is also positioned on the outer side of the main body portion 33. As a result, the engineer handles the portion of the slide extension portion 34 positioned on the outer side of the main body portion 33 to enable the insertion of the distal end of the slide extension portion 34 into the recessed portion 11b without holding the distal end of the slide extension portion 34 to be inserted into the recessed portion 11b, thereby providing an effect of improving ease of handling.

### Second Embodiment

With reference to FIG. 6 to FIG. 10, a second embodiment of the invention of the present application is described. In the first embodiment, the exchange unit 3 is inserted between the first pipeline end portion 11 and the second pipeline end portion 12 of the manifold 1 by the translational operation. In the subsequent process, the slide extension portion 34 is handled to insert the distal end thereof into the recessed portion 11b. In contrast, in the second embodiment of the invention of the present application, in the process of inserting the exchange unit 3 between the first pipeline end portion 11 and the second pipeline end portion 12 of the manifold 1 by the translational operation, the first flow path end portion 31 and the second flow path end portion 32 of the exchange unit 3 and the first pipeline end portion 11 and the second pipeline end portion 12 of the manifold 1 are coupled to each other at the same time.

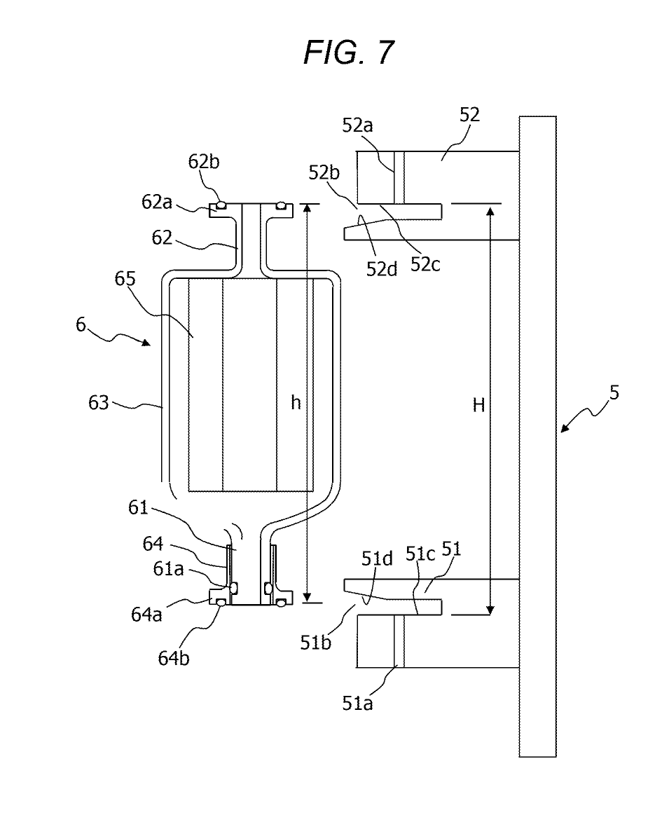

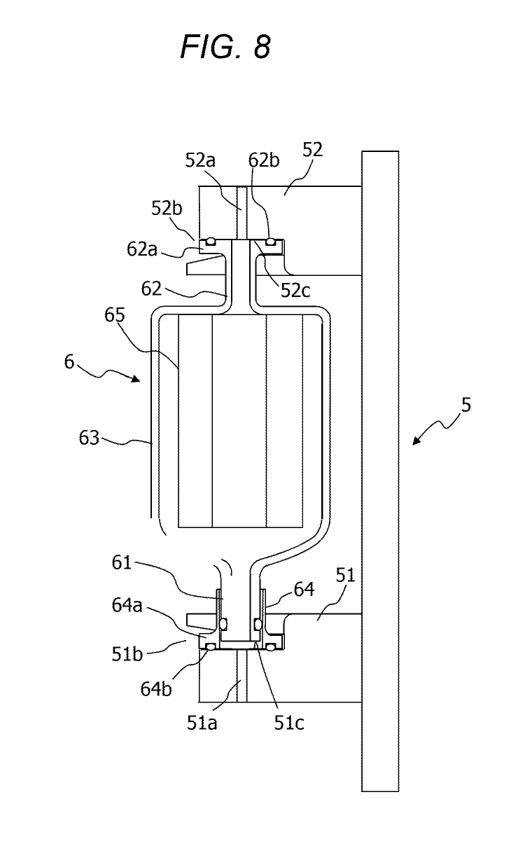

First, with reference to FIG. 7 and FIG. 8, a first mode of the second embodiment is described. FIG. 7 is a view for illustrating a state before an exchange unit 6 is inserted between a first pipeline end portion 51 and a second pipeline end portion 52 of a manifold 5 according to the second embodiment by the translational operation, and FIG. 8 is a view for illustrating a state after the insertion. The manifold 5 is provided on a flow circuit. The manifold 5 includes the first pipeline end portion 51 and the second pipeline end portion 52. The flow circuit in which the manifold 5 is mounted has a flow-path lacking portion between the first pipeline end portion 51 and the second pipeline end portion 52. The first pipeline end portion 51 and the second pipeline end portion 52 are arranged so as to be opposed to each other, and each can be constructed as, for example, a block-like member. For example, a pipeline 51a connected to a fluid source (not shown) is connected to the first pipeline end portion 51 to enable formation of an upstream side of the flow circuit, whereas a pipeline 52a connected to a destination of exhaust of the fluid (not shown) is connected to the second pipeline end portion 52 to enable formation of a downstream side of the flow circuit. However, a relationship between the upstream side and the downstream side of the manifold 5 is merely an example, and can be set oppositely. Hereinafter, the first pipeline end portion 51 side is described as the upstream side and the second pipeline end portion 52 is described as the downstream side as an example in this specification.

The first pipeline end portion 51 has an opposed surface 51c, and the second pipeline end portion 52 has an opposed surface 52c. The opposed surface 51c and the opposed surface 52c are opposed to each other. A distance H between the opposed surface 51c and the opposed surface 52c which are opposed to each other is invariable. The exchange unit 6 is removably mounted in the distance H.

The first pipeline end portion 51 has an opening 51b in a lateral direction with respect to a direction from the opposed surface 52c to the opposed surface 51c. Similarly, the first pipeline end portion 52 has an opening 52b in the lateral direction with respect to the direction from the opposed surface 52c to the opposed surface 51c. The direction from the opposed surface 52c to the opposed surface 51c is representatively a normal direction to the opposed surface 51c or the opposed surface 52c. As long as the direction is the lateral direction with respect to the direction from the opposed surface 52c to the opposed surface 51c, however, the direction is not necessarily required to be the normal direction in a strict sense.

The pipeline 51a connected to the fluid source (not shown) is connected to the opposed surface 51c of the first pipeline end portion 51, whereas the pipeline 52a connected to the destination of exhaust of the fluid is connected to the opposed surface 52c of the second pipeline end portion 52. In general, it is preferred that the pipeline 51a of the first pipeline end portion 51 and the pipeline 52a of the second pipeline end portion 52 be arranged so as to be positioned in the same straight line to reduce a flow path resistance. However, the positions thereof may be shifted, or one of the pipelines may be inclined with respect to another thereof.

Specifically, the manifold 5 constructing a part of the flow circuit system according to the present invention is the flow-path lacking portion being a part of the flow circuit. A flow path inside the exchange unit 6 is joined between the first pipeline end portion 51 being one end of the lacking portion and the second pipeline end portion 52 being another end thereof, thereby completing the flow circuit system. Then, the opening 51b and the opening 52b are formed at the one end and the another end of the manifold 5, respectively, which are the flow-path lacking portion in the lateral direction with respect to the direction from the one end to the another end.

The exchange unit 6 includes a first flow path end portion 61, a second flow path end portion 62, a main body portion 63, and a slide extension portion 64. The main body portion 63 has a hollow portion inside. A filter 65 or other members is arranged in the hollow portion. The filter 65 or other members is a filter member with an ion-exchange resin, an adsorbent such as zeolite or a diatom earth, a member obtained by combining the adsorbent and the filter member, or the like. Inside the exchange unit 6, a flow path from the first flow path end portion 61 through the filter 65 or other members to the second flow path end portion 62 is formed.

The slide extension portion 64 is mounted on the first flow path end portion 61 of the exchange unit 6. The slide extension portion 64 has such a shape as to cover at least a part of the first flow path end portion 61. In a portion of the slide extension portion 64, which is positioned on an outer side of the first flow path end portion 61, a sealing member 61a such as an O-ring configured to seal a gap between an outer surface of the first flow path end portion 61 and an inner surface of the slide extension portion 64 is provided.

The slide extension portion 64 is slidable along the first pipeline end portion 61 so as to approach or separate away from the main body portion 63. For example, a guide groove (not shown) is formed on an inner side of a portion which is positioned on an outer side of the main body portion 63. A part of the main body portion 63 is engaged with the guide groove so that the slide extension portion 64 slides therein. The slide extension portion 64 is extended from a received state of being received on the outer side of the main body portion 63 to an extended state in which a distal end of the slide extension portion 64 is extended beyond a distal end of the first flow path end portion 61.

The second flow path end portion 62 of the exchange unit 6 has a flange 62a which expands in a perpendicular direction to a direction in which the second flow path end portion 62 extends. The slide extension portion 64 which slides along the first flow path end portion 61 of the exchange unit 6 has a flange 64a which expands in a perpendicular direction to a direction in which the first flow path end portion 61 extends. The flange 64a and the flange 62a are positioned so as to be parallel respectively to the opening 51b and the opening 52b under a state in which the first flow path end portion 61 of the exchange unit 6 is oriented toward the first pipeline end portion 51 of the manifold 5 and the second flow path end portion 62 of the exchange unit 6 is oriented toward the second pipeline end portion 52 of the manifold 5. The opening 51b is formed to have approximately a flange width so that the flange 64a can be received in the opening 51b. The opening 52b is also formed to have approximately a flange width so that the flange 62a can be received in the opening 52b.

The opening 51b and the opening 52b respectively have an inclined surface 51d and an inclined surface 52b at inlet portions of the openings, which become narrower from an inlet of the opening 51b and an inlet of the opening 52b to a depth side in a mounting direction in which the exchange unit 6 is inserted between the first pipeline end portion 51 and the second pipeline end portion 52 of the manifold 5 (in a lateral direction with respect to a direction from the opposed surface 52c to the opposed surface 51c). On the depth side of the opening 51c and the depth side of the opening 52b, the flange 62a and the flange 64a can be respectively pressed against the opposed surface 51c and the opposed surface 52c. A sealing member 64b such as an O-ring is provided on a portion of the flange 64a, which abuts against the opposed surface 51c, whereas a sealing member 62b such as an O-ring is provided on a portion of the flange 62a, which abuts against the opposed surface 52c. The flange 62a is pressed against the opposed surface 52c to bring the sealing member 62b into close contact with the opposed surface 52c, whereas the flange 64a is pressed against the opposed surface 51c to bring the sealing member 64b into close contact with the opposed surface 51c. The sealing member 64b and the sealing member 62b may be respectively provided on the opposed surface 51c and the opposed surface 52c instead of being provided on the flange 64a and the flange 62a.

Subsequently, with reference to FIG. 8, there is described how the exchange unit 6 is mounted to the manifold 5. The engineer places the exchange unit 6 in the vicinity of the manifold 5 so that the first flow path end portion 61 of the exchange unit 6 is oriented toward the first pipeline end portion 51 of the manifold 5 and the second flow path end portion 62 of the exchange unit 6 is oriented toward the second pipeline end portion 52 of the manifold 5 (FIG. 7). Then, the flange 64a and the flange 62a of the exchange unit 6 are gradually inserted into the opening 51b of the first pipeline end portion 51 of the manifold 5 and the opening 52b of the second pipeline end portion 52 of the manifold 5, respectively, by the translational operation. The flange 64a and the flange 62a of the exchange unit 6 are brought into contact with the inclined surface 51d at the inlet portion of the opening 51b and the inclined surface 52d at the inlet portion of the opening 52b, respectively.

The flange 64a of the exchange unit 6 is provided to the slide extension portion 64. Therefore, as the flange 64a and the flange 62a are respectively inserted into the opening 51b and the opening 52b, the slide extension portion 64 moves so as to separate away from the main body portion 63 along the first flow path end portion 61 of the exchange unit 6. After the flange 64a and the flange 62a are completely inserted into the opening 51b and the opening 52b, respectively, the flange 64a is pressed against the opposed surface 51c and the flange 62a is pressed against the opposed surface 52c to be brought into close contact therewith. As a result, the pipeline 51a and the pipeline 52a communicate with the flow path inside the exchange unit 6 through the fluid. Specifically, in the second embodiment of the present invention, through the process of completely inserting the flange 64a and the flange 62a of the exchange unit 6 respectively into the opening 51b and the opening 52b, the pipeline 51a and the pipeline 52a communicate with the flow path inside the exchange unit 6 through the fluid at the same time, to thereby fill the lacking portion of the flow circuit. In this manner, there is provided an advantageous effect that the structural mounting of the exchange unit 6 to the manifold 5 and the coupling of the internal flow path can be achieved by the simple single process of forcing the exchange unit 6 between the first pipeline end portion 51 and the second pipeline end portion 52 of the manifold 5. For removing the exchange unit 6 from the manifold 5, a reverse process to the process described above is performed.

In the first mode of the second embodiment, the slide extension portion 64 is provided on the outer side of the first flow path end portion 61 of the exchange unit 6. However, the slide extension portion 64 is not limited to be provided on the outer side of the first flow path end portion 61 as long as the slide extension portion 64 can be extended with respect to the main body portion 63. As long as a space allows, the slide extension portion 64 may be provided on an inner side of the first flow path end portion 61. Further, the slide extension portion 64 may be provided not only for the first flow path end portion 61 but also for both the first flow path end portion 61 and the second flow path end portion 62.

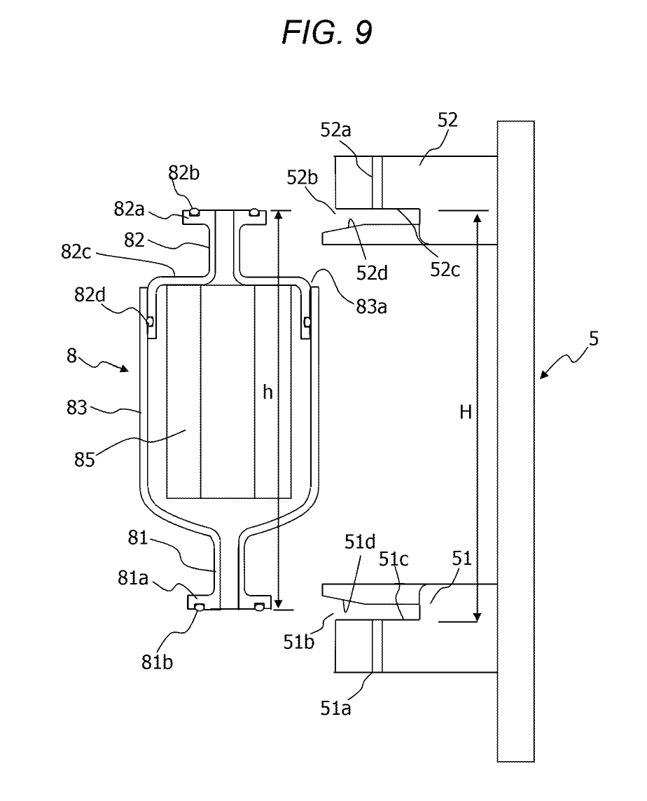

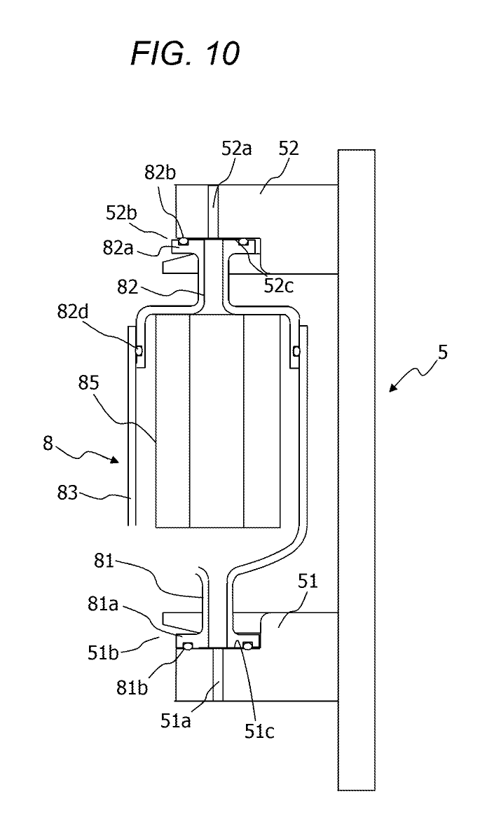

Next, with reference to FIG. 9 and FIG. 10, a second mode of the second embodiment is described. FIG. 9 is a view for illustrating the second mode of the second embodiment, for illustrating a state before an exchange unit 8 is inserted between the first pipeline end portion 51 and the second pipeline end portion 52 of the manifold 5 by the translational operation, and FIG. 10 is a view for illustrating a state after the insertion. In the first mode of the second embodiment, the slide extension portion 64 is provided as a member different from the first flow path end portion 61, the second flow path end portion 62, and the main body portion 63. However, any of the first flow path end portion 61, the second flow path end portion 62, and the main body portion 63 can be provided as the slide extension portion 64. Now, there is described an example where the second flow path end portion 62 is provided as the slide extension portion as the second mode of the second embodiment. Hereinafter, the same parts as those in the first mode of the second embodiment are omitted from description, and differences are described.

In the second mode of the second embodiment, the manifold 5 is the same as that of the first mode of the second embodiment. In the second mode of the second embodiment, the exchange unit 8 includes a first flow path end portion 81, a second flow path end portion 82, and a main body portion 83. The main body portion 83 has a hollow portion inside. A filter 85 or other members is arranged in the hollow portion, which is the same as in the second mode of the second embodiment. The second mode of the second embodiment differs from the first mode of the second embodiment in that the second flow path end portion 82 is movable with respect to the main body portion 83. Although various methods are conceivable to provide a configuration in which the second flow path end portion 82 is movable with respect to the main body portion 83, there exists the following method, for example.

For example, the first flow path end portion 81 is connected to the main body portion 83 of the exchange unit 8, whereas an opening 83a is formed on an opposite side. The second flow path end portion 82 is an elongated pipe having a through hole inside and has a flange 82a at one end of the elongated pipe, which expands at a right angle with respect to a direction in which the elongated pipe extends. The second flow path end portion 82 has a closing lid 82c at an end portion on a side opposite to the end portion at which the flange 82a is provided, which expands at a right angle with respect to the direction in which the elongated pipe extends. For example, the closing lid 82c has a cylindrical portion. The cylindrical portion of the closing lid 82c is inserted into the opening 83a of the main body portion 83 of the exchange unit 8 so that an inner surface of the main body portion 83 and an outer surface of the cylindrical portion of the closing lid 82c come into contact with each other, and functions as a closing surface which closes the opening 83a. A sealing member such as an O-ring is mounted on the outer surface of the cylindrical portion of the closing lid 82c. As a result, the inner surface of the main body portion 83 and the outer surface of the cylindrical portion of the closing lid 82c are held in close contact with each other, thereby achieving a state in which the inside fluid does not leak. The inner surface of the main body portion 83 and the outer surface of the cylindrical portion of the closing surface 82c are engaged with each other through, for example, an engagement groove (not shown). In this manner, the second flow path end portion 82 becomes movable with respect to the main body portion 83 to function as the slide extension portion of the first mode. The second flow path end portion 82 is slidable so as to approach or separate away from the main body portion 83. In this manner, a distance h from a flange surface of a flange 81a provided to the first flow path end portion 81 and a flange surface of a flange 82a of the second flow path end portion 82 is variable. In a process of mounting the exchange unit 8 to the manifold 5, the second flow path end portion 82 is extended and contracted so as to match the distance H between the opposed surface 51c of the first pipeline end portion 51 and the opposed surface 52c of the second pipeline end portion 52 of the manifold 5.

Subsequently, with reference to FIG. 10, there is described how the exchange unit 8 is mounted to the manifold 5. The engineer places the exchange unit 8 in the vicinity of the manifold 5 so that the first flow path end portion 81 of the exchange unit 8 is oriented toward the first pipeline end portion 51 of the manifold 5 and the second flow path end portion 82 of the exchange unit 8 is oriented toward the second pipeline end portion 52 of the manifold 5 (FIG. 9). Then, the flange 81a and the flange 82a of the exchange unit 8 are gradually inserted into the opening 51b of the first pipeline end portion 51 of the manifold 5 and the opening 52b of the second pipeline end portion 52 of the manifold 5, respectively, by the translational operation. The flange 81a and the flange 82a of the exchange unit 8 are brought into contact with the inclined surface 51d at the inlet portion of the opening 51b and the inclined surface 52d at the inlet portion of the opening 52b, respectively.

As the flange 81a and the flange 82a of the exchange unit 8 are inserted respectively into the opening 51b and the opening 52b, the second flow path end portion 82 moves so as to separate away from the main body portion 83. After the flange 81a and the flange 82a are completely inserted into the opening 51b and the opening 52b, respectively, the flange 81a is pressed against the opposed surface 51c and the flange 82a is pressed against the opposed surface 52c to be brought into close contact therewith. As a result, the pipeline 51a and the pipeline 52a communicate with the flow path inside the exchange unit 8 through the fluid. Specifically, in the second embodiment of the present invention, through the process of completely inserting the flange 81a and the flange 82a of the exchange unit 8 respectively into the opening 51b and the opening 52b, the pipeline 51a and the pipeline 52a communicate with the flow path inside the exchange unit 8 through the fluid at the same time, to thereby fill the lacking portion of the flow circuit. In this manner, there is provided an advantageous effect that the structural mounting of the exchange unit 8 to the manifold 5 and the coupling of the internal flow path can be achieved by the simple single process of forcing the exchange unit 8 between the first pipeline end portion 51 and the second pipeline end portion 52 of the manifold 5. For removing the exchange unit 8 from the manifold 5, a reverse process to the process described above is performed.

### REFERENCE SIGNS LIST

1, 5 manifold
3, 6, 8 exchange unit
11 first pipeline end portion
12 second pipeline end portion
31 first flow path end portion
32 second flow path end portion
33 main body portion
34 slide extension portion
35 filter or other members
51 first pipeline end portion
52 second pipeline end portion
61 first flow path end portion
62 second flow path end portion
63 main body portion
64 slide extension portion
65 filter or other members
81 first flow path end portion
82 second flow path end portion
83 main body portion
85 filter or other members

1. An exchange unit removably mounted between a first pipeline end portion and a second pipeline end portion of a manifold of a flow circuit, the manifold comprising the first pipeline end portion having a recessed portion and the second pipeline end portion, the exchange unit comprising:
a first flow path end portion having a first width;
a main body portion having a second width larger than the first width;
a second flow path end portion positioned on a side opposite to the first flow path end portion; and
a slide extension portion comprising a portion, which is larger than the first width and is configured to cover the first flow path end portion on an outer side of the first flow path end portion, and a portion, which is larger than the second width and is configured to cover the main body portion on an outer side of the main body portion,
wherein the slide extension portion is configured to be extendable from the main body portion along the main body portion and the first flow path end portion, and is capable of being inserted into the recessed portion of the first pipeline end portion when the slide extension portion is extended.

2. An exchange unit according to claim 1,
wherein the main body portion has an engaging portion, whereas the slide extension portion has a receiving portion,
wherein a sealing member is provided on any one of the main body portion and the slide extension portion and is brought into contact with another of the main body portion and the slide extension portion, and
wherein the engaging portion is engaged with the receiving portion to achieve the extension of the slide extension portion from the main body portion along the main body portion and the first flow path end portion.

3. A flow circuit system comprising a manifold being a part of a flow circuit and an exchange unit mountable to and removable from the manifold,
the manifold comprising a first pipeline end portion having a recessed portion and a second pipeline end portion,
the exchange unit comprising:
a first flow path end portion having a first width;
a main body portion having a second width larger than the first width;
a second flow path end portion positioned on a side opposite to the first flow path end portion; and
a slide extension portion comprising a portion, which is larger than the first width and is configured to cover the first flow path end portion on an outer side of the first flow path end portion, and a portion, which is larger than the second width and is configured to cover the main body portion on an outer side of the main body portion,
wherein the slide extension portion is configured to be extendable from the main body portion along the main body portion and the first flow path end portion, and is capable of being inserted into the recessed portion of the first pipeline end portion when the slide extension portion is extended.

4. A flow circuit system according to claim 3,
wherein the main body portion has an engaging portion, whereas the slide extension portion has a receiving portion,
wherein a sealing member is provided on any one of the main body portion and the slide extension portion and is brought into contact with another of the main body portion and the slide extension portion, and
wherein engagement of the engaging portion with the receiving portion and the sealing member achieve the extension of the slide extension portion from the main body portion along the main body portion and the first flow path end portion.

5. An exchange unit to be removably mounted, in a predetermined mounting direction, between a first pipeline end portion and a second pipeline end portion of a manifold of a flow circuit, the manifold comprising the first pipeline end portion and the second pipeline end portion opposed to the first pipeline end portion,
the exchange unit comprising:
a main body portion;
a first flow path end portion, which extends from the main body portion;
a second flow path end portion, which has a flange and extends from the main body portion in a direction opposite to a direction in which the first flow path end portion extends; and
a slide extension portion, which has a flange on a side opposite to the main body portion and is movable with respect to the main body portion along the first flow path end portion,
wherein, in the predetermined mounting direction for the exchange unit, the first pipeline end portion of the manifold has an opening capable of receiving the flange of the slide extension portion, whereas the second pipeline end portion of the manifold has an opening capable of receiving the flange of the second flow path end portion; and
wherein the flange of the slide extension portion is inserted into the opening of the first pipeline end portion of the manifold and the flange of the second flow path end portion is inserted into the opening of the second pipeline end portion of the manifold so that the slide extension portion is moved relative to the main body portion to change a distance between the flange of the slide extension portion and the flange of the second flow path end portion, to thereby mount the exchange unit between the first pipeline end portion and the second pipeline end portion.

6. An exchange unit according to claim 5, wherein the manifold has an inclined surface which becomes narrower in the predetermined mounting direction for the exchange unit at each of an inlet of the opening of the first pipeline end portion of the manifold and an inlet of the opening of the second pipeline end portion of the manifold.

7. A flow circuit system comprising a manifold being a part of a flow circuit and an exchange unit mountable to and removable from the manifold,
the manifold comprising a first pipeline end portion and a second pipeline end portion,
the exchange unit to be removably mounted between the first pipeline end portion and the second pipeline end portion in a predetermined mounting direction, the exchange unit comprising:
a main body portion;
a first flow path end portion, which extends from the main body portion;
a second flow path end portion, which has a flange and extends from the main body portion in a direction opposite to a direction in which the first flow path end portion extends; and
a slide extension portion, which has a flange on a side opposite to the main body portion and is movable along the first flow path end portion with respect to the main body portion,
wherein, in the predetermined mounting direction for the exchange unit, the first pipeline end portion of the manifold has an opening capable of receiving the flange of the slide extension portion, whereas the second pipeline end portion of the manifold has an opening capable of receiving the flange of the second flow path end portion, and
wherein the flange of the slide extension portion is inserted into the opening of the first pipeline end portion of the manifold and the flange of the second flow path end portion is inserted into the opening of the second pipeline end portion of the manifold so that the slide extension portion is moved relative to the main body portion to change a distance between the flange of the slide extension portion and the flange of the second flow path end portion, to thereby mount the exchange unit between the first pipeline end portion and the second pipeline end portion.

8. An exchange unit to be removably mounted, in a predetermined mounting direction, between a first pipeline end portion and a second pipeline end portion of a manifold of a flow circuit, the manifold comprising the first pipeline end portion and the second pipeline end portion opposed to the first pipeline end portion,
the exchange unit comprising:
a main body portion, which has an opening at one end;
a first flow path end portion, which has a flange and extends from the main body portion; and
a second flow path end portion, which has a closing surface configured to cover the opening of the main body portion at one end and a flange at another end, extends on a side opposite to the main body portion, and is mounted movably with respect to the main body portion,
wherein, in the predetermined mounting direction for the exchange unit, the first pipeline end portion of the manifold has an opening capable of receiving the flange of the first flow path end portion, whereas the second pipeline end portion of the manifold has an opening capable of receiving the flange of the second flow path end portion, and
wherein the flange of the first flow path end portion is inserted into the opening of the first pipeline end portion of the manifold and the flange of the second flow path end portion is inserted into the opening of the second pipeline end portion of the manifold so that the second flow path end portion is moved relative to the main body portion to change a distance between the flange of the first flow path end portion and the flange of the second flow path end portion, to thereby mount the exchange unit between the first pipeline end portion and the second pipeline end portion.

9. An exchange unit according to claim 8, wherein the manifold has an inclined surface which becomes narrower in the predetermined mounting direction for the exchange unit at each of an inlet of the opening of the first pipeline end portion of the manifold and an inlet of the opening of the second pipeline end portion of the manifold.

10. A flow circuit system comprising a manifold being a part of a flow circuit and an exchange unit mountable to and removable from the manifold,
the manifold comprising a first pipeline end portion and a second pipeline end portion,
the exchange unit to be removably mounted between the first pipeline end portion and the second pipeline end portion in a predetermined mounting direction,
the exchange unit comprising:
a main body portion, which has an opening at one end;
a first flow path end portion, which has a flange and extends from the main body portion; and
a second flow path end portion, which has a closing surface configured to cover the opening of the main body portion at one end and a flange at another end, extends on a side opposite to the main body portion, and is mounted movably with respect to the main body portion,
wherein, in the predetermined mounting direction for the exchange unit, the first pipeline end portion of the manifold has an opening capable of receiving the flange of the first flow path end portion, whereas the second pipeline end portion of the manifold has an opening capable of receiving the flange of the second flow path end portion, and
wherein the flange of the first flow path end portion is inserted into the opening of the first pipeline end portion of the manifold and the flange of the second flow path end portion is inserted into the opening of the second pipeline end portion of the manifold so that the second flow path end portion is moved relative to the main body portion to change a distance between the flange of the first flow path end portion and the flange of the second flow path end portion, to thereby mount the exchange unit between the first pipeline end portion and the second pipeline end portion.
